(19) United States
(12) Patent Application Publication
(10) Pub. No.: US 2003/0046412 A1
(43) Pub. Date: Mar. 6, 2003

(54) Content delivery system using a proxy content server

(75) Inventors: Tetsuhiro Tsunoda, Tokyo (JP); Makoto Sakaki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/229,099

(22) Filed: Aug. 28, 2002

(30) Foreign Application Priority Data
Aug. 29, 2001 (JP) 2001-258905

(51) Int. Cl. G06F 15/16

(52) U.S. Cl. 709/229; 709/249

(57) ABSTRACT

A proxy content server responds to a request message from a user terminal by determining whether the message is a registration request or a content request. If the message is a registration request, the proxy content server maps the user terminal to a registered content server in a memory. If the message is a content request for requesting a content from a server, the proxy content server requests it to send content data to the user terminal if the content server is registered in the memory and the user terminal is mapped to the registered content server. If the user terminal is not mapped to the requested server, the user is not entitled to access the requested server and informed of this fact.

### BACKGROUND OF THE INVENTION

1. Field of the Invention

The present invention relates generally to content delivery networks, and more specifically to a content management system.

2. Description of the Related Art

The recent tendency of internet service providers is to place restrictions on content delivery by granting access to specified content sites (i.e., content servers) only to subscribed users. By identifying user terminals, the internet service providers are able to charge their users on delivered contents such as video and audio products for creating multimedia applications. In the prior art system, the content server has the responsibility for verifying the authentication of users, managing their registration/cancellation and billing the users if the delivered content is a pay item.

However, with an increasing number of subscribed users, the content access traffic is overloading the content servers with a resultant increase in transactions and complexity.

Additionally, with the proliferation of wireless communication terminals, it is desired that wireless network providers provide proxy content delivery service.

### SUMMARY OF THE INVENTION

It is therefore an object of the present invention to provide proxy content delivery for reducing the burden on the content servers.

It is another object of the present invention to provide proxy content delivery for delivering pay contents to subscribed users and charging the users for the delivered contents.

According to one aspect of the present invention, there is provided a proxy content server comprising a memory device, and a processor for receiving a request message from a user terminal, the request message being either a registration request message or a content request message which requests access to a content server. The processor is responsive to the registration request message for (a) mapping the user terminal to a registered content server in the memory device, and is responsive to the content request message for (b) requesting the registered content server to send content data to the user terminal if the content server requested by the content request message is a registered content server and the user terminal is mapped to the registered content server, and (c) informing the user terminal that the user terminal is not entitled to access the registered content server if the user terminal is not mapped thereto in the memory device.

According to a second aspect, the present invention provides an internet service provider connected to an IP (internet protocol) network, comprising a web switch for establishing a connection between a user terminal and one of a plurality of output ports, and a proxy content server connected to one of the output ports of the web switch for receiving a request message from the user terminal, the request message being either a registration request message or a content request message which requests access to a content server. The proxy content server is responsive to the registration request message for (a) mapping the user terminal to a registered content server in a memory device, and is responsive to the content request message for (b) requesting the registered content server to send content data to the user terminal if the content server requested by the content request message is a registered content server and the user terminal is mapped to the registered content server, and (c) informing the user terminal that the user terminal is not entitled to access the registered content server if the user terminal is not mapped thereto in the memory device.

According to a third aspect, the present invention provides a method of gaining access to one of a plurality of content servers connected to an IP network, comprising the steps of: (a) receiving a request message from a user terminal and determining whether the message is a registration request message or a content request message which requests access to a content server, (b) if the received message is the registration request message, mapping the user terminal to a registered content server, and (c) if the received message is the content request message, requesting the content server to send content data to the user terminal if the content server is a registered content server and the user terminal is mapped to the registered content server, and informing the user terminal that the user terminal is not entitled to access the content server if the user terminal is not mapped to the registered content server.

### BRIEF DESCRIPTION OF THE DRAWIGNS

The present invention will be described in detail further with reference to the following drawings, in which:

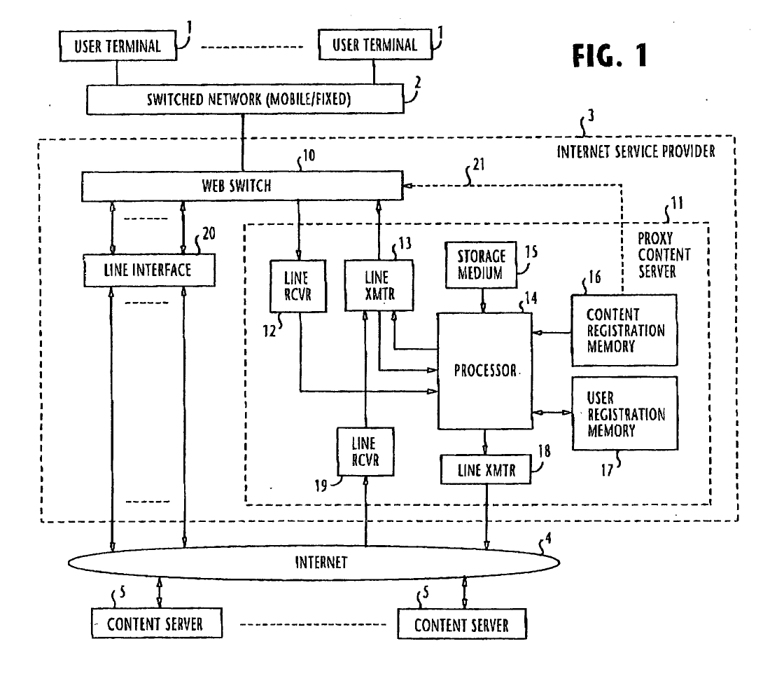

FIG. 1 is a block diagram of a content delivery system of the present invention;

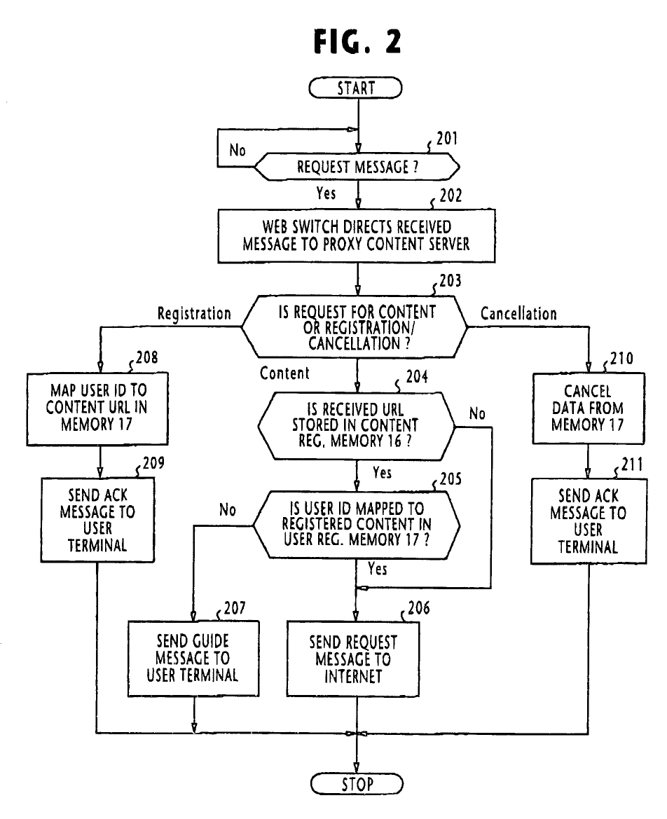

FIG. 2 is a flowchart of the operation of the proxy content server of FIG. 1 according to a first embodiment of the present invention;

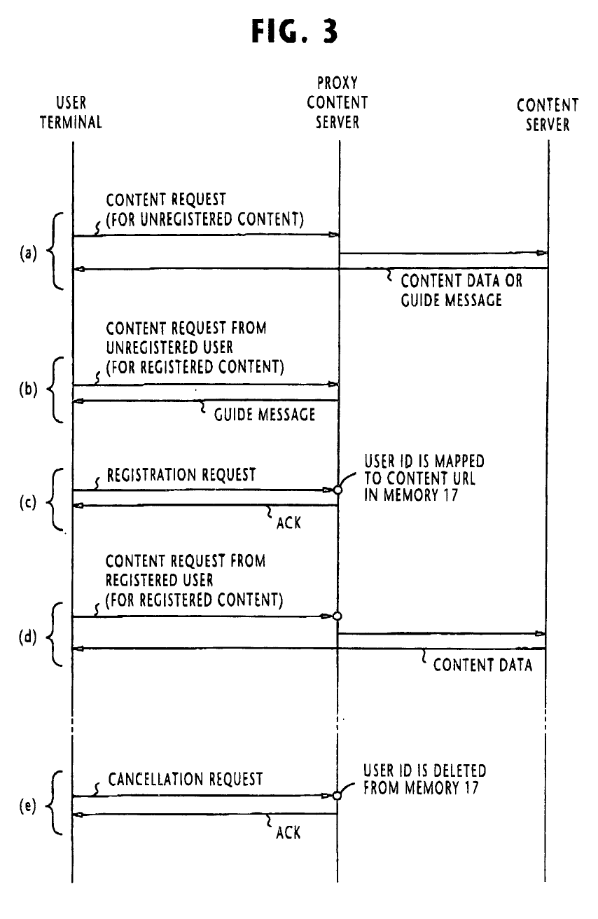

FIG. 3 is a sequence diagram associated with the flowchart of FIG. 2;

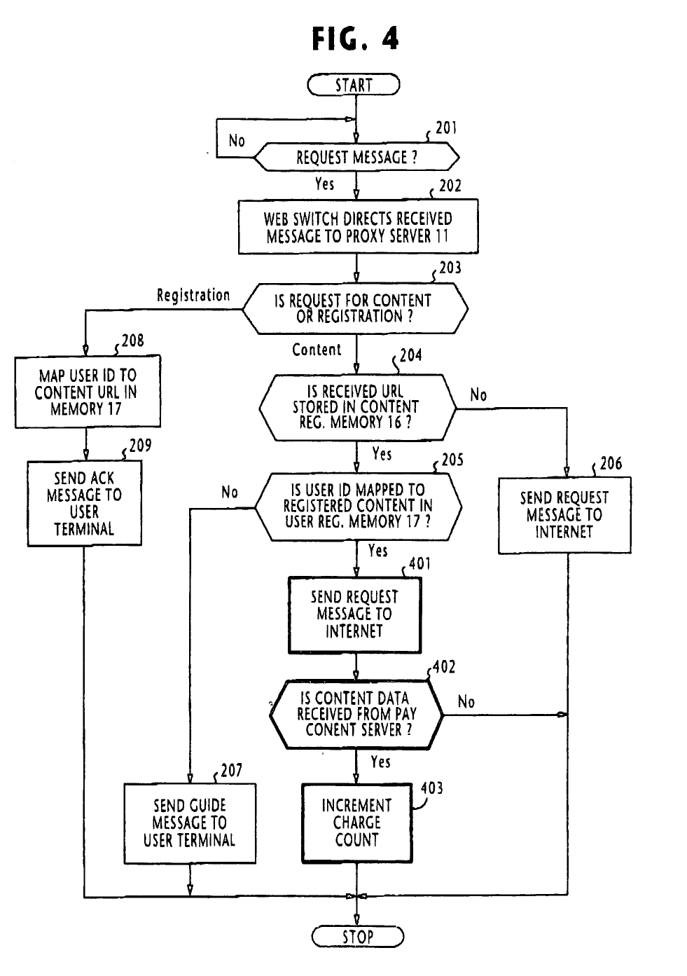

FIG. 4 is a flowchart of the operation of the proxy content server of FIG. 1 according to a second embodiment of the present invention;

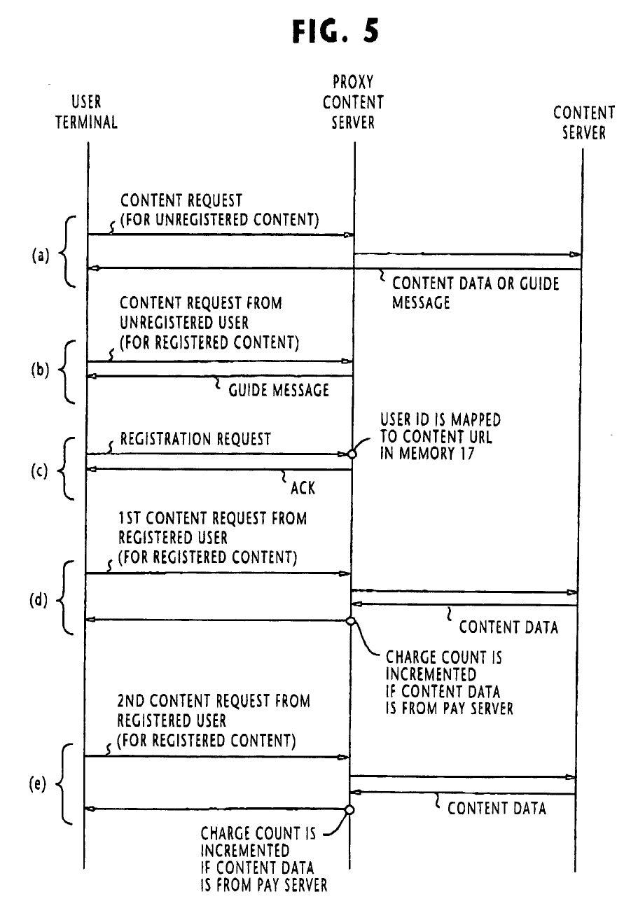

FIG. 5 is a sequence diagram associated with the flowchart of FIG. 4; and

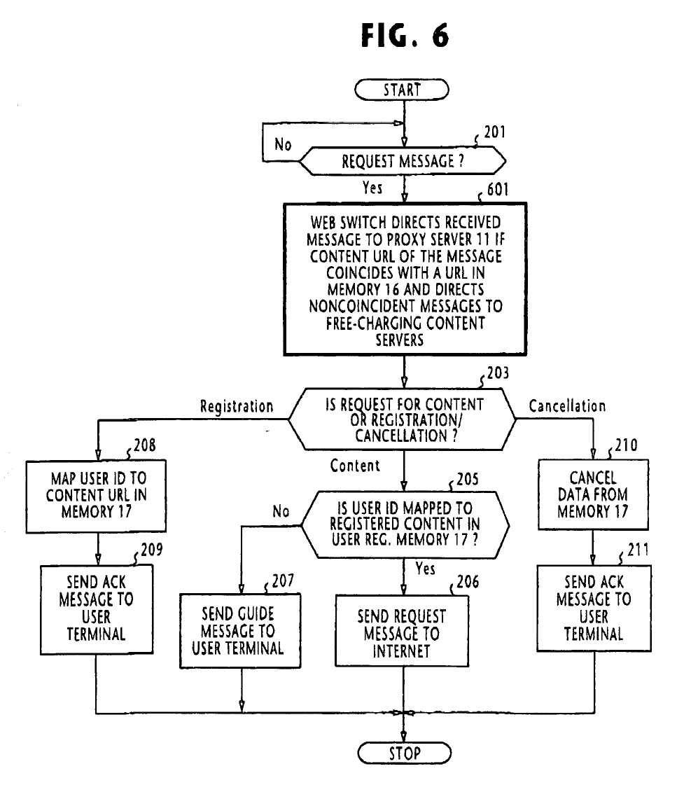

FIG. 6 is a flowchart of the modification of FIG. 2.

### DETAILED DESCRIPTION

Referring to FIG. 1, there is shown a content delivery system of the present invention. The content delivery system is comprised of an internet service provider 3 to which a plurality of user terminals 1 are accessible via a switched network 2 such as mobile or fixed communications network. Internet service provider 3 is accessible to a plurality of content servers 5 via an IP (internet protocol) network 4. Some of these content servers are pay servers and others are free-of-charge content servers.

Internet service provider 3 is comprised of a web switch 10 with its user-side port connected to the switched network 2. Web switch 10 has a load-balancing function that establishes connections to various internet servers by balancing their traffic loads through its server-side ports of the switch 10, to which a proxy content server 11 and a line interface 20 are connected.

Proxy content server 11 includes a line receiver 12 for receiving packets from a user terminal and a line transmitter 13 for transmitting packets to the user terminal. A processor 14 is connected to the line receiver 12 to receive user's message and processes the received message according to a program stored in a storage medium 15.

A memory device comprising a content registration memory 16 and a user registration memory 17 is connected to the processor 14. The URLs (Uniform Resource Locators) of content servers (either pay or free-of-charge server) whose transactions with user terminals are handled by the proxy content server are registered in the content registration memory 16, and these content servers are hereinafter called “registered content servers”. The user identifiers of terminals 1, which are entitled to access the registered content servers, are stored in the user registration memory 17 by the processor 14.

Processor 14 repeats a request message to the internet 4 via a line transmitter 18 if the message is from either a registered or unregistered user and the requested content server is not registered in the memory 16. In this case, content data or a guide message is received from the internet, depending on whether the content server is a pay server or a free-of-charge server. At the proxy content server, such content data or guide message is received by a line receiver 19 and repeated through the line transmitter 13 to the unregistered user terminal.

Further, the processor 14 repeats a request message to the internet 4 via the line transmitter 18 if the message is from a registered user and the requested content server is registered in the memory 16. In this case, content data is transmitted from the registered content server and received by the line receiver 19 and repeated through the line transmitter 13 to the registered user terminal.

The users may be charged on the basis of registration time period, such as a monthly payment basis, or on a per-access basis. In the latter case, the processor 14 receives information from the line transmitter 13 indicating that content data has been received from a pay content server and transmitted to the requesting user terminal. In response to this information, the processor increments a charge count value in the entry of the user in the user registration memory 17.

Additionally, the processor 14 may send a guide message to the requesting user terminal when an unregistered user terminal attempts to access a registered content server and sends an acknowledgement message when a user terminal has been registered in or canceled from the user registration memory 17.

All line receivers and transmitters perform conversion of signaling codes between bipolar line codes for transmission and unipolar digital signals for data processing within the proxy content server.

In response to a content request message from a user terminal 1, the web switch 10 examines the URL contained in the message and establishes a connection between the user terminal and the proxy content server according to the known load-balancing algorithm. If the web switch 10 receives an email, it establishes a connection to the internet 4 via the line interface 20.

According to a first embodiment of the present invention, it is assumed that the proxy content server 11 is accessible to both registered and unregistered content servers and that the users are charged on a time charge basis, such as monthly payment.

FIG. 2 illustrates the operation of the proxy content server 11 according to the first embodiment of the present invention.

When a request message is received (step 201), the web switch 10 directs the message to the processor 14 via the line receiver 12 (step 202).

At step 203, the processor 14 determines whether the received message is a content request message or a registration/cancellation request message. If the message is a content request message, the processor 14 proceeds to step 204 to read the URL of the content request message and searches the content registration memory 16 for the same content URL. If the same content URL is not found in the memory 16, flow proceeds to step 206 to retransmit the received content request message to the internet 4, whereby the message is forwarded to an unregistered content server. As a result, content data is transmitted from the internet 4 to the proxy content server 11 if the unregistered content server is a free-of-charge content server or a guide message is transmitted from the internet if the unregistered content server is a pay content server (see part (a) of FIG. 3). Such a guide message notifies that the requested content server is not free of charge and indicates a cost schedule of the requested content server.

If the URL of the content request message is found in the content registration memory 16 at step 204, the processor knows that the user is attempting to access a registered content server and proceeds to step 205 to determine if the user identifier contained in the message is mapped in the user registration memory 17 to the URL of the registered content server. If the user identifier is not mapped to that URL, flow proceeds from step 205 to step 207 to send a guide message back to the requesting user terminal and terminates the routine (see part (b) of FIG. 3). If the requested content server is a pay server, the guide message will indicate a cost schedule. Otherwise, it simply encourages the user to subscribe to the proxy content server.

In response to the guide message from the proxy content server 11 (step 207), the user may send a registration request message to the proxy content server 11. The registration request message is detected at step 203 and the user identifier of the message is mapped to the URL of the requested registered content server in the user registration memory 17 (step 208). An acknowledgment message is then sent to the user terminal at step 209, indicating that the user has been registered (subscribed) to the requested registered content server (see part (c) of FIG. 3).

In response to the acknowledgment message, the user terminal will send a first content request message requesting content from the registered s content server. Since the requested content server is registered and the user identifier of this content request message is mapped to the URL of the registered content server (steps 204, 205), the decisions at steps 204 and 205 are both affirmative and flow proceeds to step 206 to retransmit the received message to the internet 4. As a result, the message is forwarded to the registered content server and content data is transmitted therefrom (see part (d) of FIG. 3).

If the user cancels his/her registration, the user terminal sends a cancellation request message to the proxy content server 11. In this case, flow proceeds from step 203 to step 210, where the processor cancels the corresponding user-URL data from the user registration memory 17 and sends an acknowledgment message to the user at step 211, indicating that the registration of the user terminal has been cancelled (see part (e) of FIG. 3).

According to a second embodiment of the present invention, it is assumed that the proxy content server 11 is accessible to both registered and unregistered content servers as in the previous embodiment and that the users are charged on a per access basis.

FIG. 4 illustrates the operation of the proxy content server 11 according to the second embodiment of the present invention, which differs from the previous embodiment by the provision of steps 401 to 403 following the affirmative decision at step 205. Therefore, events that occur prior to the event of a registered user accessing a registered content server are identical to those of FIG. 3 as illustrated in parts (a), (b) and (c) of FIG. 5.

In response to the acknowledgment message, the user will send a first content request message for the registered content server, and in response, the decisions at steps 204 and 205 are both affirmative and flow proceeds to step 401 to retransmit the received message to the internet 4. The message is forwarded to the registered content server via the internet and content data is returned. This content data is received by the line receiver 19 and sent to the line transmitter 13. When the line transmitter 13 has transmitted the content data to the requesting user, it supplies information to the processor 14 as to whether the content data is a pay content or free-of-charge. Following step 401, the processor proceeds to step 402 to check to see if the information supplied from the line transmitter 13 indicates that the content data is a pay content. If this is the case, the processor increments the charge count value of the registered user in the user entry of registration memory 17 (see part (d) of FIG. 5).

When the registered user sends a second content request message for the registered pay content server, steps 204, 205, 401 to 403 will be repeated and the charge count value of the user is incremented (see part (e) of FIG. 5).

As a modification of the previous embodiments, the web switch 10 has access to the content registration memory 16 as indicated by a dotted line 21 in FIG. 1. In response to a request message, the web switch 10 examines the content registration memory to determine whether the message is to be directed to the proxy content server 11 or the line interface 20.

FIG. 6 is a flowchart which is a modified version the flowchart of FIG. 2, for example. In FIG. 6, step 202 of FIG. 2 is replaced with step 601 and step 204 is removed.

Following the reception of a request message at decision step 201, the web switch 10 determines, at step 601, whether the content URL of the request message coincides with a content URL in the content registration memory 16 and directs the received message to the proxy content server 11 if is a coincidence is detected between the URLs in the message and the memory 16. If no coincidence is detected, the web switch 10 directs the message to the line interface 20, whereby the message is transmitted to unregistered content servers via the internet 4.

Therefore, the proxy content server 11 is only responsible for request messages requesting contents from the registered content servers. Hence, the traffic load of the proxy content server 11 is reduced.

What is claimed is:

1. A proxy content server comprising:
a memory device; and
a processor for receiving a request message from a user terminal, said request message being either a registration request message or a content request message which requests access to a content server,
wherein said processor is responsive to said registration request message for (a) mapping the user terminal to a registered content server in said memory device, and is responsive to said content request message for (b) requesting the registered content server to send content data to said user terminal if the content server requested by the content request message is a registered content server and the user terminal is mapped to the registered content server, and (c) informing said user terminal that the user terminal is not entitled to access the registered content server if said user terminal is not mapped thereto in said memory device.

2. The proxy content server of claim 1, where the processor transmits the received message to the IP network if the content server requested by the content request message is not a registered content server.

3. The proxy content server of claim 1, wherein said processor increments a charge count value for charging said user terminal when content data received from said content server has been transmitted to the user terminal.

4. The proxy content server of claim 1, wherein said processor determines whether the received message is a cancellation request message and cancels the mapped relationship between the user terminal and the registered content server if the received message is said cancellation request message.

5. An internet service provider connected to an IP (internet protocol) network, comprising:
a web switch for establishing a connection between a user terminal and one of a plurality of output ports; and
a proxy content server connected to one of said output ports of said web switch for receiving a request message from said user terminal, said request message being either a registration request message or a content request message which requests access to a content server,
wherein said proxy content server is responsive to said registration request message for (a) mapping the user terminal to a registered content server in a memory device, and is responsive to said content request message for (b) requesting the registered content server to send content data to said user terminal if the content server requested by the content request message is a registered content server and the user terminal is mapped to the registered content server, and (c) informing said user terminal that the user terminal is not entitled to access the registered content server if said user terminal is not mapped thereto in said memory device.

6. The internet service provider of claim 5, where the proxy content server transmits the received message to the IP network if the content server requested by the content request message is not a registered content server.

7. The internet service provider of claim 5, wherein said proxy content server increments a charge count value for charging said user terminal when content data received from said content server has been transmitted to the user terminal.

8. The internet service provider of claim 5, wherein said proxy content server determines whether the received message is a cancellation request message and cancels the mapped relationship between the user terminal and the registered content server if the received message is said cancellation request message.

9. The internet service provider of claim 5, wherein said web switch directs a message received from said user terminal to said proxy content server if the received message is requesting access to a content server registered in said memory device and directs the received message to said IP network if the received message is requesting access to a content server not registered in said memory device.

10. A method of gaining access to one of a plurality of content servers connected to an IP (internet protocol) network, comprising the steps of:
a) receiving a request message from a user terminal and determining whether the message is a registration request message or a content request message which requests access to a content server;
b) if the received message is said registration request message, 8 mapping the user terminal to a registered content server; and
c) if the received message is said content request message, requesting the content server to send content data to said user terminal if the content server is a registered content server and said user terminal is mapped to the registered content server, and informing said user terminal that the user terminal is not entitled to access said content server if said user terminal is not mapped to the registered content server.

11. The method of claim 10, wherein step (c) further comprises transmitting the received message to the IP network if the content server requested by the content request message is not a registered content server.

12. The method of claim 10, wherein step (c) further comprises incrementing a charge count value for charging said user terminal when content data received from said content server has been transmitted to the user terminal,

13. The method of claim 10, wherein step (a) further comprises determining whether the received message is a cancellation request message, further comprising the step of canceling the mapped relationship between the user terminal and the registered content server if the received message is said cancellation request message.

14. A computer readable storage medium containing a computer-executable program, the program comprising the steps of:
a) receiving a request message from a user terminal and determining whether the message is a registration request message or a content request message which requests access to a content server;
b) if the received message is said registration request message, mapping the user terminal to a registered content server; and
c) if the received message is said content request message, requesting the content server to send content data to said user terminal if the content server is the registered content server and said user terminal is mapped to the registered content server, and informing said user terminal that the user terminal is not entitled to access said content server if said user terminal is not mapped to the registered content server.

15. The computer readable storage medium of claim 14, wherein step (c) further comprises transmitting the received message to an IP (internet protocol) network if the content server requested by the content request message is not a registered content server.

16. The computer readable storage medium of claim 14, wherein step (c) further comprises incrementing a charge count value for charging said user terminal when content data received from said content server has been transmitted to the user terminal.

17. The computer readable storage medium of claim 14, wherein step (a) further comprises determining whether the received message is a cancellation request message, further comprising the step of canceling the mapped relationship between the user terminal and the registered content server if the received message is said cancellation request message.
